(19) United States
(12) Patent Application Publication
(10) Pub. No.: US 2018/0171180 A1
(43) Pub. Date: Jun. 21, 2018

(54) MANUFACTURE OF GOLF CLUB HEAD

(71) Applicant: Acushnet Company, Fairhaven, MA (US)

(72) Inventor: Michael E. Franz, San Diego, CA (US)

(73) Assignee: Acushnet Company, Fairhaven, MA (US)

(21) Appl. No.: 15/387,412

(22) Filed: Dec. 21, 2016

(51) Int. Cl. C09J 5/00; A63B 53/04; B21K 17/00; B23K 31/02; B23K 37/08

(52) U.S. Cl. CPC C09J 5/00; A63B 53/047; B23K 2201/04; B23K 31/02; B23K 37/08; B21K 17/00

(57) ABSTRACT

A method of forming a golf club head, including placing a first portion of the golf club head adjacent a the second portion of the golf club head; welding the first portion to the second portion forming a first weld bead; injecting hot melt into an interior of the golf club head through an injection hole after forming the first weld bead; and welding the injection hole shut, forming a second weld bead.

### TECHNICAL FIELD

This present technology generally relates to systems, devices, and methods related to golf clubs, and more specifically to the manufacture of golf club heads having a hollow enclosed cavity.

### DESCRIPTION OF THE RELATED TECHNOLOGY

In order to continually improve the performance of a golf club, golf club designers are constantly searching for new and innovative ways make a golf club perform better. One way to improve the performance of golf club head, particularly an iron type golf club head, is to form a hollow enclosed cavity. This construction can be used to increase performance characteristics of the golf club head, including center of gravity location, coefficient of restitution, and moment of inertia. Including a hollow enclosed cavity introduces an additional challenge to golf club head construction however. Hollow enclosed cavities can trap particles, including portions of weld beads inside the cavity. These particles inside the cavity can rattle inside the golf club head. In order to prevent the trapped particles from rattling against the walls of the cavity, a hole can be machined creating an injection hole, allowing hot melt to be injected from the exterior of the golf club head into the cavity. Hot melt is sometimes also referred to as rat glue. After injecting hot melt, the injection hole is plugged with a plastic plug or covered with a medallion. The hot melt remains in the cavity, and remains sticky, such that any particles in the cavity moving around in the cavity stick to the hot melt, preventing rattles.

The process of machining the hot melt injection hole adds cost to the golf club manufacturing process. Additionally, the plug can be undesirable to the aesthetics of the golf club head. Thus, there exists a need for an improved method of constructing a golf club head with a hollow interior cavity.

### SUMMARY

The systems, methods, and devices described herein have innovative aspects, no single one of which is indispensable or solely responsible for their desirable attributes. Without limiting the scope of the claims, some of the advantageous features will now be summarized.

One non-limiting embodiment of the present technology includes a method of forming a golf club head, including: forming a first portion of the golf club head; wherein the first portion of the golf club head comprises a rear portion of a blade portion of the golf club head; wherein the first portion comprises a first half of an injection hole at a periphery of the first portion; forming a second portion of a golf club head; wherein the second portion of the golf club head comprises a striking face of the blade portion of the golf club head; wherein the second portion comprises a second half of the injection hole at a periphery of the second portion; placing the first portion adjacent the second portion; wherein the first half of the injection hole is adjacent the second half of the injection hole; welding the first portion to the second portion forming a first weld bead, wherein the first weld bead does not seal the injection hole; injecting hot melt into an interior of the golf club head through the injection hole; welding the injection hole shut, forming a second weld bead; and polishing the first weld bead and the second weld bead.

An additional non-limiting embodiment of the present technology includes a method of forming a golf club head, including: forming a first portion of the golf club head; forming a second portion of a golf club head; placing the first portion adjacent the second portion; welding the first portion to the second portion forming a first weld bead; wherein an injection hole is located at the intersection of the first portion and the second portion; wherein the first weld bead does not fill the injection hole; injecting hot melt into an interior of the golf club head through the injection hole; and welding the injection hole shut, forming a second weld bead.

In an additional non-limiting embodiment of the present technology the first portion of the golf club head comprises a rear portion of a blade portion of the golf club head.

In an additional non-limiting embodiment of the present technology the second portion of the golf club head comprises a striking face of the blade portion of the golf club head.

In an additional non-limiting embodiment of the present technology the injection hole is partially formed in the first portion and partially formed in the second portion.

In an additional non-limiting embodiment of the present technology the second weld bead is formed via spot welding.

In an additional non-limiting embodiment of the present technology the golf club head is an iron-type golf club head including a hollow cavity.

In an additional non-limiting embodiment of the present technology the injection hole is located on a sole of the golf club head.

In an additional non-limiting embodiment of the present technology the injection hole is located on a toe of the golf club head.

An additional non-limiting embodiment of the present technology includes polishing the first weld bead and the second weld bead.

In an additional non-limiting embodiment of the present technology the injection hole is formed via casting.

In an additional non-limiting embodiment of the present technology the injection hole is formed via forging.

An additional non-limiting embodiment of the present technology includes a method of forming a golf club head, including: placing a first portion of the golf club head adjacent a the second portion of the golf club head; welding the first portion to the second portion forming a first weld bead; injecting hot melt into an interior of the golf club head through an injection hole after forming the first weld bead; and welding the injection hole shut, forming a second weld bead.

In an additional non-limiting embodiment of the present technology the first portion of the golf club head comprises a rear portion of a blade portion of the golf club head.

In an additional non-limiting embodiment of the present technology the second portion of the golf club head comprises a striking face of the blade portion of the golf club head.

In an additional non-limiting embodiment of the present technology n the injection hole is located adjacent the first weld bead.

In an additional non-limiting embodiment of the present technology the golf club head is an iron-type golf club head including a hollow cavity.

In an additional non-limiting embodiment of the present technology the injection hole is located on a sole of the golf club head.

In an additional non-limiting embodiment of the present technology the injection hole is located on a toe of the golf club head.

An additional non-limiting embodiment of the present technology includes polishing the first weld bead and the second weld bead.

### BRIEF DESCRIPTION OF THE DRAWINGS

The accompanying drawings form a part of the specification and are to be read in conjunction therewith. The illustrated embodiments, however, are merely examples and are not intended to be limiting. Like reference numbers and designations in the various drawings indicate like elements.

FIG. 1 illustrates a perspective view of one embodiment of an iron type golf club head.

FIG. 2 illustrates an additional perspective view of the iron type golf club head of FIG. 1.

FIG. 3 illustrates an exploded-view of the iron type golf club head of FIG. 1.

FIG. 4 illustrates an additional exploded-view of the iron type golf club head of FIG. 1.

FIG. 5A illustrates a partial view of one embodiment of the sole of the iron type golf club head including an injection hole, prior to welding.

FIG. 5B illustrates the partial view from FIG. 5A, after welding the blade portion to the back portion.

FIG. 5C illustrates the partial view from FIG. 5B, with hot melt being injected through the injection hole.

FIG. 5D illustrates the partial view from FIG. 5C, after the injection hole has been sealed with a spot weld.

FIG. 5E illustrates the partial view from FIG. 5D, after the weld and spot weld have been polished flush with the external surface of the golf club head.

FIG. 6 illustrates the process of forming a golf club head with hot melt inside a hollow cavity.

### DETAILED DESCRIPTION

In the following detailed description, reference is made to the accompanying drawings, which form a part of the present disclosure. The illustrative embodiments described in the detailed description, drawings, and claims are not meant to be limiting. Other embodiments may be utilized, and other changes may be made, without departing from the spirit or scope of the subject matter presented herein. It will be readily understood that the aspects of the present disclosure, as generally described herein, and illustrated in the Figures, can be arranged, substituted, combined, and designed in a wide variety of different configurations, all of which are explicitly contemplated and form part of this disclosure. For example, a system or device may be implemented or a method may be practiced using any number of the aspects set forth herein. In addition, such a system or device may be implemented or such a method may be practiced using other structure, functionality, or structure and functionality in addition to or other than one or more of the aspects set forth herein. Alterations and further modifications of inventive features illustrated herein, and additional applications of the principles of the inventions as illustrated herein, which would occur to one skilled in the relevant art and having possession of this disclosure, are to be considered within the scope of the invention.

Other than in the operating examples, or unless otherwise expressly specified, all of the numerical ranges, amounts, values and percentages such as those for amounts of materials, moments of inertias, center of gravity locations, loft and draft angles, and others in the following portion of the specification may be read as if prefaced by the word “about” even though the term “about” may not expressly appear with the value, amount, or range. Accordingly, unless indicated to the contrary, the numerical parameters set forth in the following specification and attached claims are approximations that may vary depending upon the desired properties sought to be obtained by the present invention. At the very least, and not as an attempt to limit the application of the doctrine of equivalents to the scope of the claims, each numerical parameter should at least be construed in light of the number of reported significant digits and by applying ordinary rounding techniques.

Notwithstanding that the numerical ranges and parameters setting forth the broad scope of the invention are approximations, the numerical values set forth in the specific examples are reported as precisely as possible. Any numerical value, however, inherently contains certain errors necessarily resulting from the standard deviation found in their respective testing measurements. Furthermore, when numerical ranges of varying scope are set forth herein, it is contemplated that any combination of these values inclusive of the recited values may be used.

In describing the present technology, the following terminology may have been used: The singular forms “a,” “an,” and “the” include plural referents unless the context clearly dictates otherwise. Thus, for example, reference to an item includes reference to one or more items. The term “plurality” refers to two or more of an item. The term “substantially” means that the recited characteristic, parameter, or value need not be achieved exactly, but that deviations or variations, including for example, tolerances, measurement error, measurement accuracy limitations and other factors known to those of skill in the art, may occur in amounts that do not preclude the effect the characteristic was intended to provide. A plurality of items may be presented in a common list for convenience. However, these lists should be construed as though each member of the list is individually identified as a separate and unique member. Thus, no individual member of such list should be construed as a de facto equivalent of any other member of the same lists solely based on their presentation in a common group without indications to the contrary. Furthermore, where the terms “and” and “or” are used in conjunction with a list of items, they are to be interpreted broadly, in that any one or more of the listed items may be used alone or in combination with other listed items. The term “alternatively” refers to a selection of one of two or more alternatives, and is not intended to limit the selection of only those listed alternative or to only one of the listed alternatives at a time, unless the context clearly indicated otherwise.

Features of the present disclosure will become more fully apparent from the following description and appended claims, taken in conjunction with the accompanying drawings. After considering this discussion, and particularly after reading the section entitled “Detailed Description” one will understand how the illustrated features serve to explain certain principles of the present disclosure.

Embodiments described herein generally relate to systems, devices, and methods related to golf club heads having a hollow enclosed cavity. More specifically, the present invention includes a method of incorporating hot melt into the hollow interior cavity of a golf club head at minimal expense and with superior aesthetic qualities.

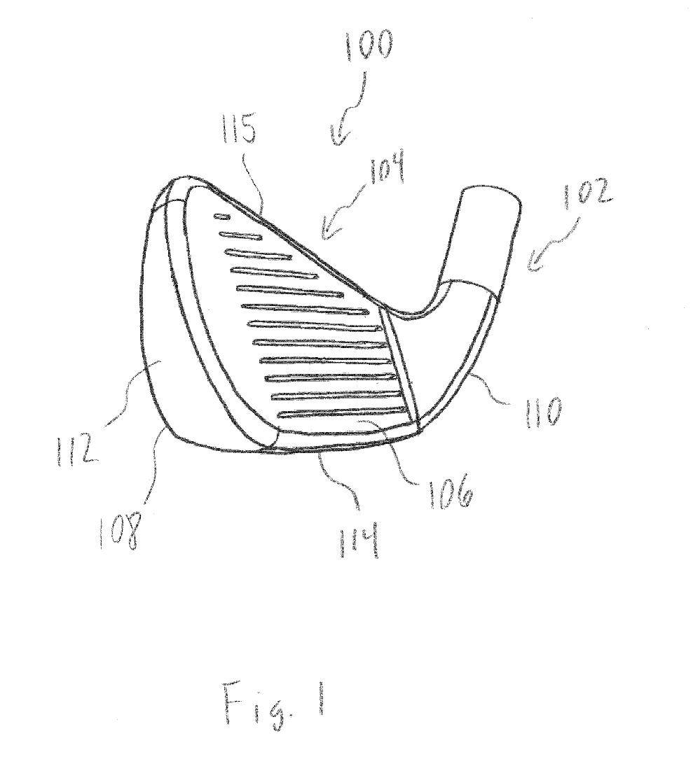

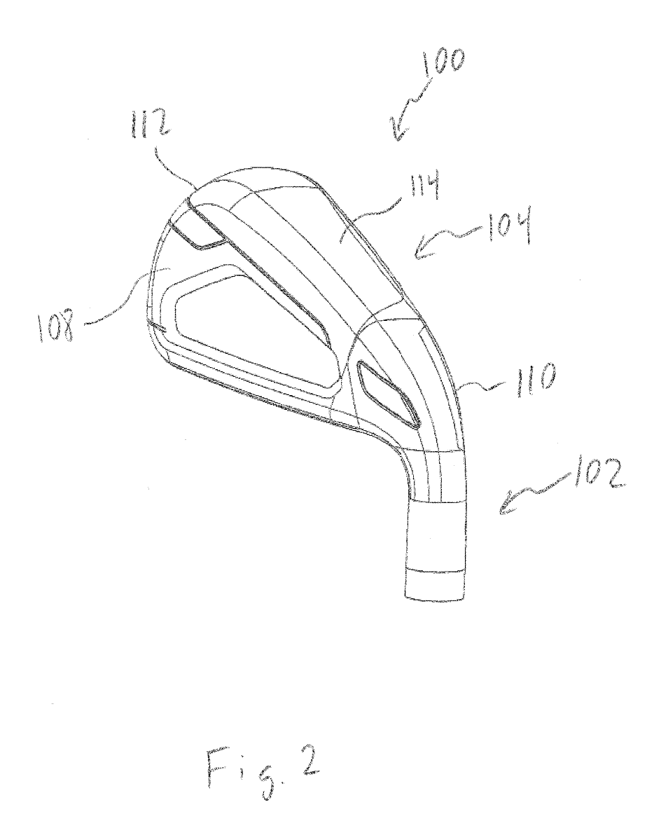

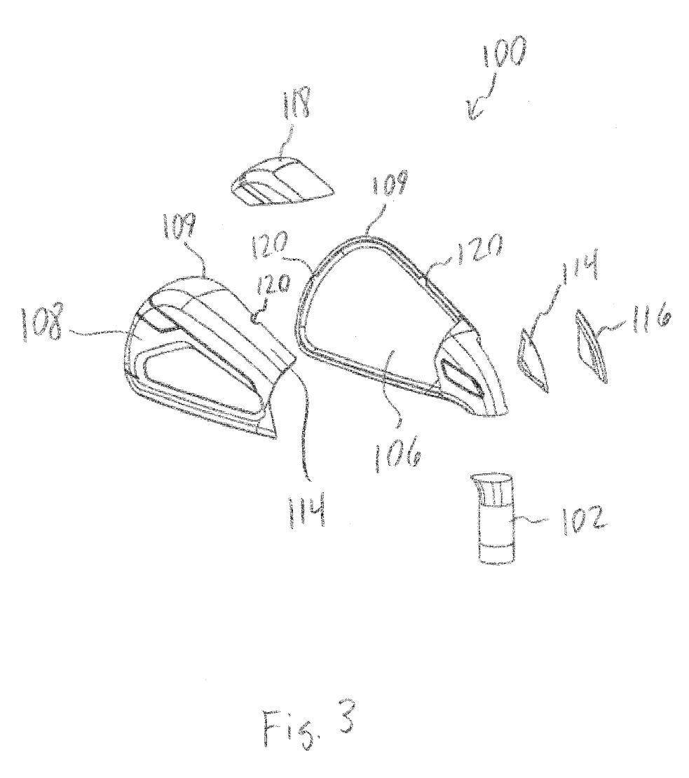

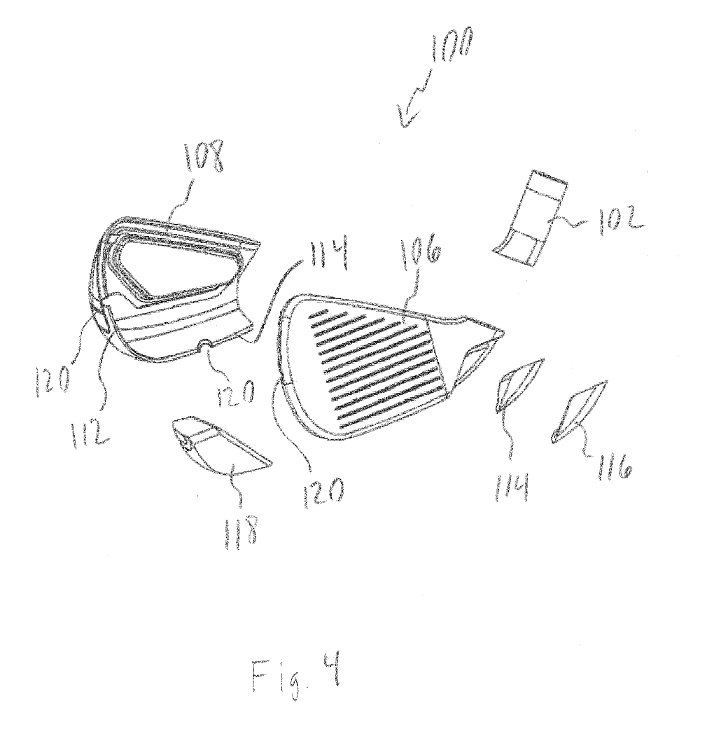

FIG. 1 illustrates a perspective view of one embodiment of an iron type golf club head 100. FIG. 2 illustrates an additional perspective view of the iron type golf club head 100 of FIG. 1. FIG. 3 illustrates an exploded-view of the iron type golf club head 100 of FIG. 1. FIG. 4 illustrates an additional exploded-view of the iron type golf club head 100 of FIG. 1.

As illustrated in FIGS. 1 and 2, the golf club head 100 includes a hosel 102 and a blade portion 104. The hosel is located on the heel side 110 of the golf club head 100, opposite the toe 112. The blade portion 104 includes a striking face 106, a rear portion 108, a sole 114, and a topline 115. The sole 114 is located at the bottom of the blade portion 104. The top line 115 is located along the top of the blade portion 104. The striking face 106 forms the front of the blade portion 104 and is configured to strike a golf ball. The rear portion 108 is located behind the striking face 106 and forms a hollow cavity inside the golf club head 100.

As illustrated in FIGS. 3 and 4, the golf club head 100 can be formed of several pieces. The rear portion 108 can be formed separately from the striking face 106. They can be joined via welding along the weld line 109 where the rear portion 108 meets the striking face 106, forming a hollow cavity inside. The striking face 106 can include a return and form at least a portion of the top line 106, toe 112, and sole 114. The rear portion 108 can also form at least a portion of the top line 106, toe 112, and sole 114.

Both the striking face 106 and the rear portion 108 can incorporate at least a portion of an injection hole 120. The injection hole 120 can be located on the sole 114 or on the toe 112. FIGS. 3 and 4 include injection holes on both the sole 114 and the toe 112 for ease of illustration, but a golf club head 100 will generally only include one injection hole. The injection hole 120 may be formed partially in both the striking face 106 and rear portion 108. Preferably, half of the injection hole 120 is formed in the striking face 106 and half is formed in the rear portion 108. As illustrated in FIGS. 3 and 4, the injection hole is located on the weld line 109. In an additional embodiment, the injection hole 120 is formed entirely in the striking face 106 or the rear portion 108, but it is adjacent the weld line (not illustrated).

The different pieces of the golf club head 100, including the striking face 106 and the rear portion 108 can be formed in a variety of ways, which may include, for example, casting, stamping, forging, etc. The injection hole 120 can be formed in the pieces during those manufacturing processes, rather than requiring an additional machining operation. Additionally, as illustrated in FIGS. 3 and 4, the golf club head can include additional pieces which are welded together to form the golf club head, which may include the hosel, weights 112, 118, and a weight cap 116. Different golf club head constructions are possible and the injection hole 120 can be formed on the weld line 109 between any two portions of the golf club head 100 as long as the injection hole 120 gives access to the hollow cavity inside the golf club head. While the golf club head 100 illustrated and described herein is an iron-type golf club head, the construction techniques described herein, particularly those regarding the injection hole, are also applicable to metalwood golf club head construction, in addition to wedges and putters including hollow cavities. Other constructions are possible which may include, for example, any of the constructions described in U.S. patent application Ser. No. 14/747,219, Multi-Material Iron Type Golf Club Head, filed on Jun. 23, 2015, currently pending, which is hereby incorporated by reference in its entirety.

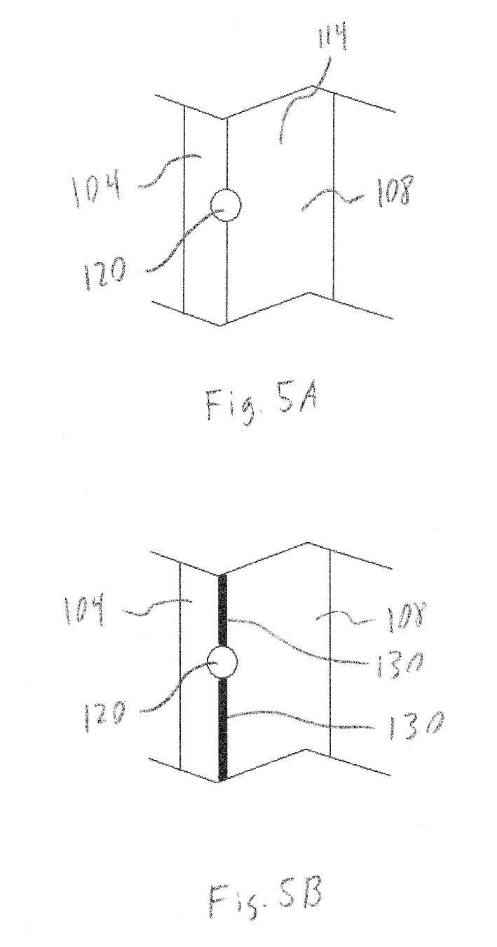

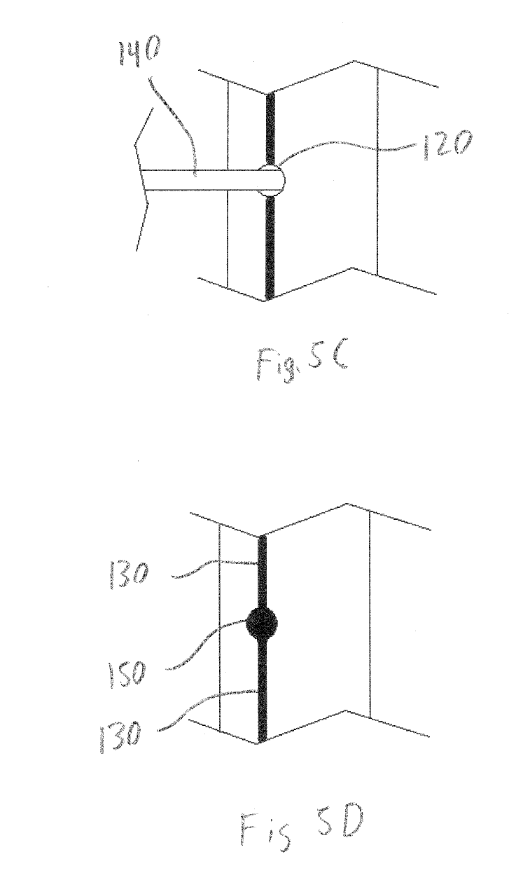

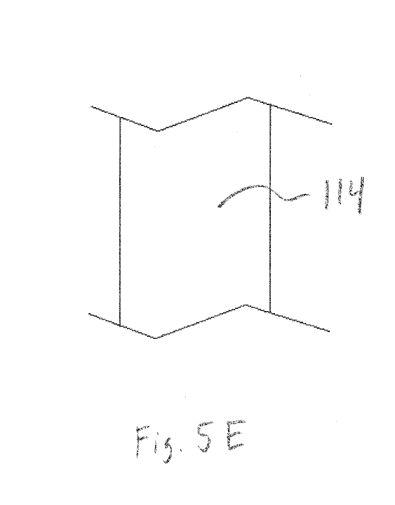

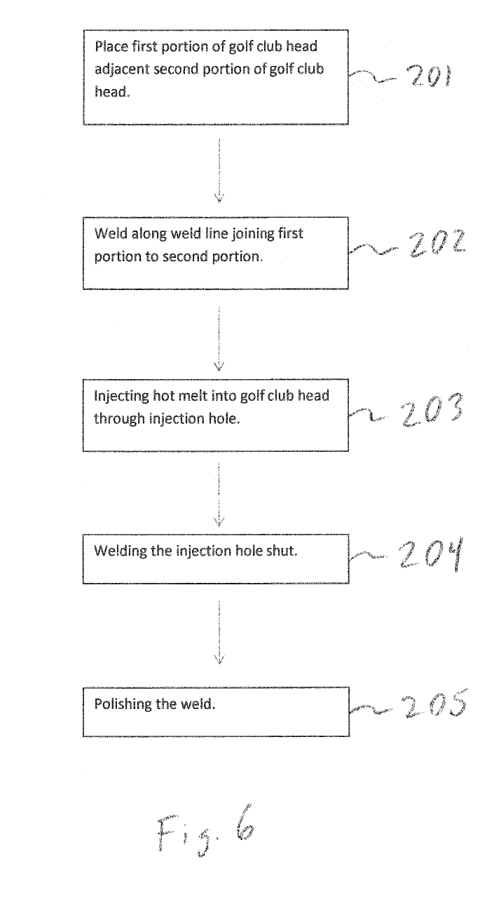

FIG. 5A illustrates a partial view of one embodiment of the sole of the iron type golf club head 100 including an injection hole, prior to welding. FIG. 5B illustrates the partial view from FIG. 5A, after welding the blade portion to the back portion. FIG. 5C illustrates the partial view from FIG. 5B, with hot melt being injected through the injection hole. FIG. 5D illustrates the partial view from FIG. 5C, after the injection hole has been sealed with a spot weld. FIG. 5E illustrates the partial view from FIG. 5D, after the weld and spot weld have been polished flush with the external surface of the golf club head. FIG. 6 illustrates the process of forming a golf club head with hot melt inside a hollow cavity.

As illustrated in FIGS. 5A, the first step 201 includes placing the first portion, or the rear portion 108, adjacent the second portion, or the striking face 106. As illustrated in FIG. 5B, the next step 202 includes welding along the weld line 109, creating a weld 130, joining the first portion to the second portion. The weld should completely join the first portion to the second portion with the exception of the injection hole 120, which is not welded shut during this step. As illustrated in FIG. 5C, the next step 203 includes injecting hot melt into the golf club head through the injection hole 120. This can be performed with a hot melt injection device 140 which heats the hot melt so that it can flow through the injection hole 120 and into the hollow cavity inside the golf club head 100. As illustrated in FIG. 5D, the next step 204 is to weld the injection hole 120 shut, leaving a weld 150 where the injection hole was previously located. This can be done with the same welding methods used to create the rest of the weld 130, or a spot welder can be utilized. As illustrated in FIG. 5E, the next step 205 is to polish off the protruding portion of the welds 130, 150, creating a smooth finish on the exterior of the golf club head, and in this case, the sole 114.

It is important that the majority of the welding is completed prior to injecting the hot melt. After the majority of welding is completed, the head is allowed to cool before injecting the hot melt. Then the final spot weld is applied. The hot melt can only withstand a certain temperature before it becomes permanently ineffective at catching particles within the golf club head. If the hot melt were injected prior to the majority of the welding, the hot melt would be destroyed. By waiting, and only performing a small weld of the injection hole after injecting hot melt, the temperature of the golf club head is only elevated slightly, and the hot melt remains effective. Additionally, by locating the injection hole 120 on the weld line 109, the process of creating the injection hole when creating the pieces of the golf club head 100 is easier. Additionally, the polishing process after welding is also easier as the polishing is still confined to the weld line, and doesn't require an additional area to be polished.

In describing the present technology herein, certain features that are described in the context of separate implementations also can be implemented in combination in a single implementation. Conversely, various features that are described in the context of a single implementation also can be implemented in multiple implementations separately or in any suitable sub combination. Moreover, although features may be described above as acting in certain combinations and even initially claimed as such, one or more features from a claimed combination can in some cases be excised from the combination, and the claimed combination may be directed to a sub combination or variation of a sub combination.

Various modifications to the implementations described in this disclosure may be readily apparent to those skilled in the art, and the generic principles defined herein may be applied to other implementations without departing from the spirit or scope of this disclosure. Thus, the claims are not intended to be limited to the implementations shown herein, but are to be accorded the widest scope consistent with this disclosure as well as the principle and novel features disclosed herein.

We claim:

1. A method of forming a golf club head, comprising:
forming a first portion of said golf club head;
wherein said first portion of said golf club head comprises a rear portion of a blade portion of said golf club head;
wherein said first portion comprises a first half of an injection hole at a periphery of said first portion;
forming a second portion of a golf club head;
wherein said second portion of said golf club head comprises a striking face of said blade portion of said golf club head;
wherein said second portion comprises a second half of said injection hole at a periphery of said second portion;
placing said first portion adjacent said second portion;
wherein said first half of said injection hole is adjacent said second half of said injection hole;
welding said first portion to said second portion forming a first weld bead, wherein said first weld bead does not seal said injection hole;
injecting hot melt into an interior of said golf club head through said injection hole;
welding said injection hole shut, forming a second weld bead; and
polishing said first weld bead and said second weld bead.

2. A method of forming a golf club head, comprising:
forming a first portion of said golf club head;
forming a second portion of a golf club head;
placing said first portion adjacent said second portion;
welding said first portion to said second portion forming a first weld bead;
wherein an injection hole is located at the intersection of said first portion and said second portion;
wherein said first weld bead does not fill said injection hole;
injecting hot melt into an interior of said golf club head through said injection hole; and
welding said injection hole shut, forming a second weld bead.

3. The method of claim 2, wherein said first portion of said golf club head comprises a rear portion of a blade portion of said golf club head.

4. The method of claim 2, wherein said second portion of said golf club head comprises a striking face of said blade portion of said golf club head.

5. The method of claim 2, wherein said injection hole is partially formed in said first portion and partially formed in said second portion.

6. The method of claim 2, wherein said second weld bead is formed via spot welding.

7. The method of claim 2, wherein said golf club head is an iron-type golf club head comprising a hollow cavity.

8. The method of claim 2, wherein said injection hole is located on a sole of said golf club head.

9. The method of claim 2, wherein said injection hole is located on a toe of said golf club head.

10. The method of claim 2, further comprising polishing said first weld bead and said second weld bead.

11. The method of claim 2, wherein said injection hole is formed via casting.

12. The method of claim 2, wherein said injection hole is formed via forging.

13. A method of forming a golf club head, comprising:
placing a first portion of said golf club head adjacent a said second portion of said golf club head;
welding said first portion to said second portion forming a first weld bead;
injecting hot melt into an interior of said golf club head through an injection hole after forming said first weld bead; and
welding said injection hole shut, forming a second weld bead.

14. The method of claim 13, wherein said first portion of said golf club head comprises a rear portion of a blade portion of said golf club head.

15. The method of claim 13, wherein said second portion of said golf club head comprises a striking face of said blade portion of said golf club head.

16. The method of claim 13, wherein said injection hole is located adjacent said first weld bead.

17. The method of claim 13, wherein said golf club head is an iron-type golf club head comprising a hollow cavity.

18. The method of claim 13, wherein said injection hole is located on a sole of said golf club head.

19. The method of claim 13, wherein said injection hole is located on a toe of said golf club head.

20. The method of claim 13, further comprising polishing said first weld bead and said second weld bead.
